(19) United States
(12) Patent Application Publication
(10) Pub. No.: US 2025/0254664 A1
(43) Pub. Date: Aug. 7, 2025

(54) Measurement Periods and Measurement Approaches for a Non-Terrestrial Network

(71) Applicant: Apple Inc., Cupertino, CA (US)

(72) Inventors: Jie Cui, San Jose, CA (US); Qiming Li, Beijing (CN); Dawei Zhang, Saratoga, CA (US); Hong He, Cupertino, CA (US); Yang Tang, San Jose, CA (US); Xiang Chen, Campbell, CA (US); Huaning Niu, San Jose, CA (US); Chunxuan Ye, San Diego, CA (US)

(21) Appl. No.: 18/854,670

(22) PCT Filed: Apr. 22, 2022
(86) PCT No.: PCT/CN2022/088469

§ 371 Date: Oct. 7, 2024

(51) Int. Cl. H04W 72/0446; H04W 36/00; H04W 84/06

(52) U.S. Cl. CPC H04W 72/0446; H04W 36/0088; H04W 84/06

(57) ABSTRACT

This disclosure relates to techniques for a wireless device to perform measurements of satellite reference signals in a non-terrestrial wireless communication system. According to the techniques described herein, a wireless device may establish communication with a cellular base station. The wireless device and network may exchange configuration information and/or capability information related to measurements of satellite reference signals. The wireless device and network may determine scaling factor or otherwise achieve a common understanding of the measurements.

### PRIORITY INFORMATION

This application is a national stage entry of PCT Application No. PCT/CN2022/088469, entitled “Measurement Periods and Measurement Approaches for a Non-Terrestrial Network,” filed Apr. 22, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for a wireless device to perform measurements associated with a non-terrestrial wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc. The proliferation in wireless communication techniques and standards can encompass terrestrial networks as well as non-terrestrial networks (NTNs) such as 3GPP satellite networks.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for a wireless device to determine measurement periods in a non-terrestrial wireless communication system.

A method, by a user equipment device (UE), may comprise establishing communication with a cellular network and receiving, from the cellular network, configuration information. The configuration information may comprise: a first measurement timing configuration for measurement of satellite reference signals from satellites of multiple types; and a second measurement timing configuration, different from the first measurement timing configuration, for measurement of satellite reference signals. The method may further comprise determining whether first measurement opportunities according to the first measurement timing configuration overlap with second measurement opportunities according to the second measurement timing configuration in a time domain and determining a first number of satellites associated with the first measurement timing configuration. A first scaling factor may be determined based at least on: whether the first measurement opportunities overlap with the second measurement opportunities in the time domain; and the first number of satellites. The method may include performing first measurements of satellite reference signals according to the first measurement timing configuration, wherein a time period for the first measurements is determined based on the first scaling factor.

A method, by a user equipment device (UE), may comprise establishing communication with a cellular network and receiving, from the cellular network, configuration information. The configuration information may comprise: a first measurement timing configuration for measurement of satellite reference signals from satellites of multiple types; and a second measurement timing configuration, different from the first measurement timing configuration, for measurement of satellite reference signals. The method may further comprise performing first measurements of satellite reference signals according to the first measurement timing configuration, wherein said performing first measurements comprises one of: prioritizing measurement of a first type of satellites and dropping measurement of a second type of satellites; prioritizing measurement of at least one satellite indicated by the cellular network for prioritization; or dropping all measurement for the first measurement timing configuration.

A method, by a cellular base station, may comprise establishing communication with a user equipment device (UE) and transmitting, to the UE, configuration information. The configuration information may comprise: a first measurement timing configuration for measurement of satellite reference signals from satellites of multiple types; and a second measurement timing configuration, different from the first measurement timing configuration, for measurement of satellite reference signals. The method may further comprise determining whether first measurement opportunities according to the first measurement timing configuration overlap with second measurement opportunities according to the second measurement timing configuration in a time domain and determining a first number of satellites associated with the first measurement timing configuration. A first scaling factor may be determined based at least on: whether the first measurement opportunities overlap with the second measurement opportunities in the time domain; and the first number of satellites. The method may include receiving, from the UE, a report of first measurements of satellite reference signals according to the first measurement timing configuration, wherein a time period for the first measurements is determined based on the first scaling factor.

Note that the techniques described herein may be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings.

FIG. 1 illustrates an exemplary (and simplified) wireless communication system, according to some embodiments.

FIG. 2 illustrates an exemplary base station in communication with an exemplary wireless user equipment (UE) device, according to some embodiments.

FIG. 3 illustrates an exemplary block diagram of a UE, according to some embodiments.

FIG. 4 illustrates an exemplary block diagram of a base station, according to some embodiments.

FIG. 5 is a network infrastructure diagram illustrating aspects of an exemplary 3GPP satellite network deployment, according to some embodiments.

FIGS. 6-7 are schematic diagrams illustrating possible interworking between 3GPP terrestrial and satellite radio access networks (RANs), according to some embodiments.

FIG. 8 is a communication flow diagram illustrating aspects of an exemplary possible method for determination of measurement periods in a non-terrestrial wireless communication system, according to some embodiments.

FIGS. 9-10 are timing diagrams illustrating possible measurement configurations and intervals, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
NTN: Non-terrestrial Network
TX: Transmission/Transmit
RX: Reception/Receive
RAT: Radio Access Technology
TRP: Transmission-Reception-Point
TA: Timing Advance
DCI: Downlink Control Information
GEO: geosynchronous equatorial orbit
LEO: low earth orbit
MEO: medium earth orbit
SS: synchronization signal
SMTC: SS block measurement timing configuration

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

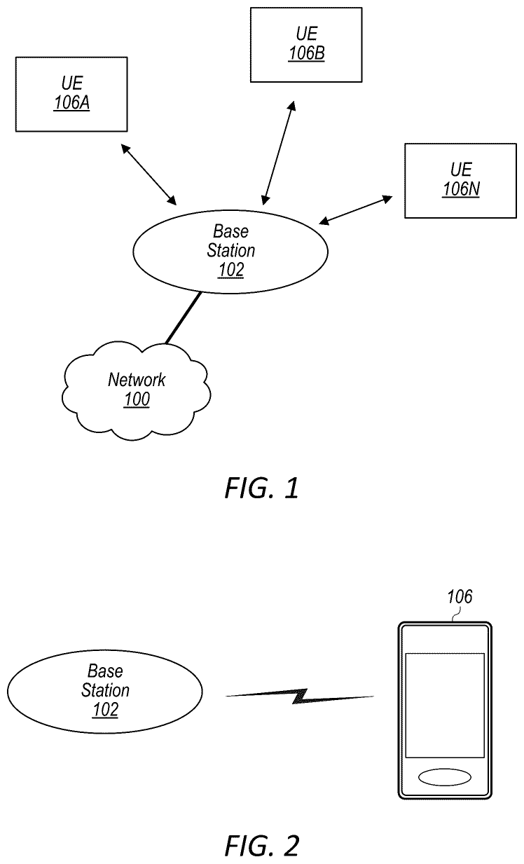

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for a wireless device to perform gradual timing adjustments in a non-terrestrial wireless communication system, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH™. Other configurations are also possible.

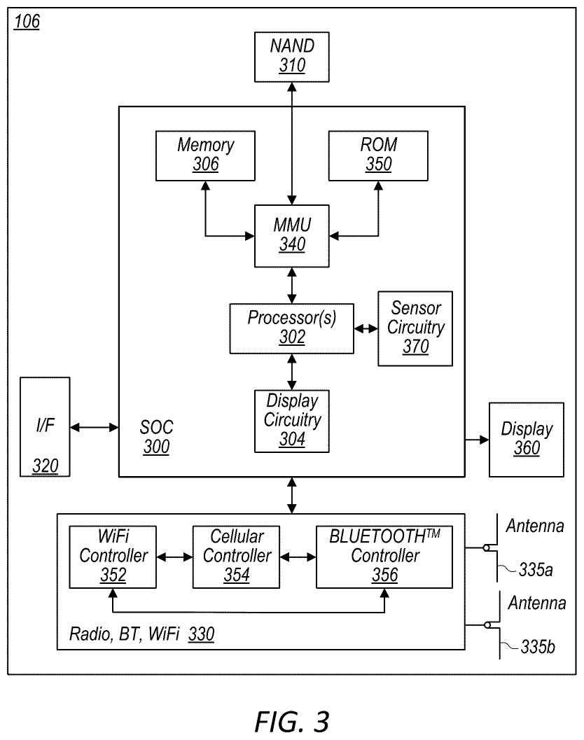

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include or couple to at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform gradual timing adjustments in a non-terrestrial wireless communication system in a wireless communication system, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform gradual timing adjustments in a non-terrestrial wireless communication system according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g. LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

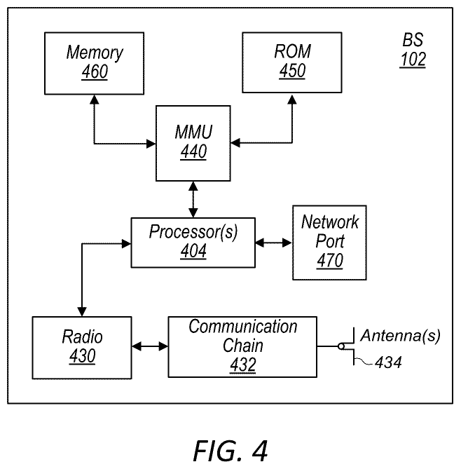

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

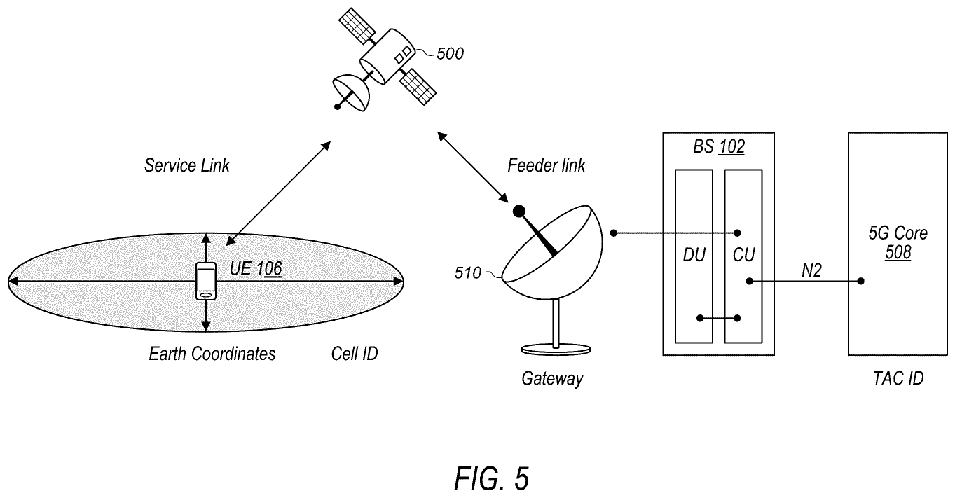

### FIGS. 5-7—3GPP Satellite Network Infrastructure

FIG. 5 is a network infrastructure diagram illustrating a 3GPP satellite network deployment, according to some embodiments. As illustrated, a satellite 500 may provide a service link to a UE 106. The service link may be used for uplink and/or downlink communications. The service link may be used for measurements. For example, the satellite may transmit or broadcast reference signals which the UE may receive and use for measurements. The UE 106 may operate within a cell, e.g., provided by a BS 102 (e.g., a gNB). The satellite 500 may also conduct communications with a terrestrial gateway 510 via a feeder link, and the gateway 510 may in turn be communicatively coupled to a base station 102. The base station 102 may include a distributed unit (DU) and a centralized unit (CU). The base station 102 may be coupled to a 5G Core Network (5GC) 508 with a tracking area code (TAC) via an N2 interface. Note that the satellite 500 may include any of various types of satellites, for example such as a geosynchronous equatorial orbit (GEO) satellite, a low earth orbit (LEO) satellite, or a medium earth orbit (MEO) satellite, among various possibilities. Further, it will be appreciated that the UE, gateway, and/or BS may communicate with any number of satellites, e.g., including multiple types of satellites.

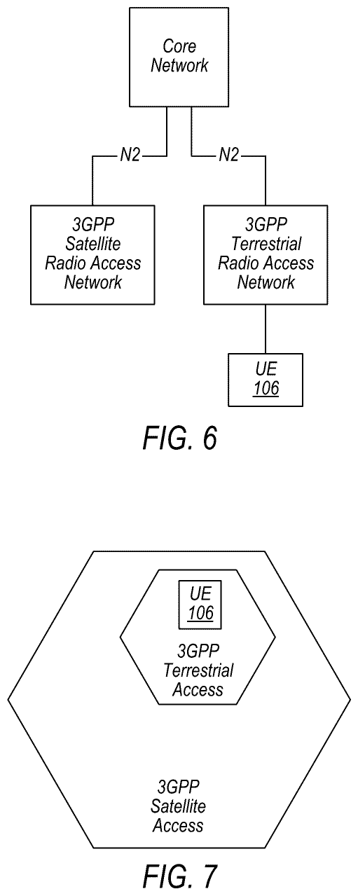

FIGS. 6-7 are schematic diagrams illustrating interworking between 3GPP terrestrial and satellite radio access networks (RANs), according to some embodiments. As illustrated, in FIG. 6, a UE 106 may communicate with a 3GPP terrestrial RAN, e.g., through a BS as shown in FIGS. 1-2. The 3GPP terrestrial RAN may be coupled via an N2 interface with a core network. A 3GPP satellite RAN may also be coupled to the core network via an N2 interface. The UE may also communicate with the core network via the satellite RAN.

FIG. 7 illustrates a UE 106 operating with a cell to obtain 3GPP terrestrial access. The UE 106 may also operate within a broader geographic range that provides 3GPP satellite access.

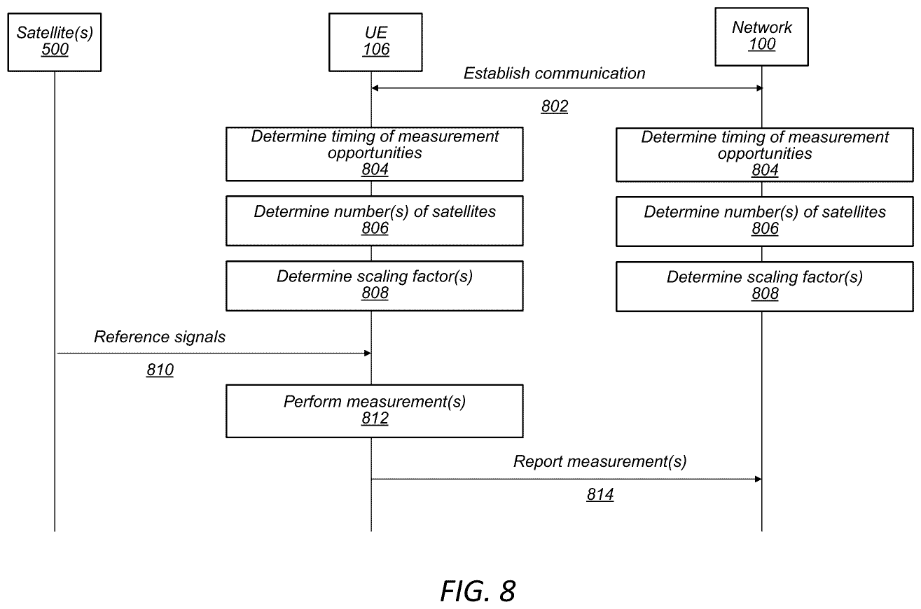

### FIG. 8—Determining Measurement Periods in a Non-Terrestrial Network

In a wireless communication system that includes non-terrestrial elements (which may be referred to herein as a non-terrestrial network or NTN, even if one or more elements of the system are terrestrially based, as may be common) such as satellites, high altitude platforms, aircrafts, etc., it may be the case that a UE may be in range of multiple satellites at a time. Further, a UE may be configured to measure reference signals from multiple satellites, potentially of different types. Thus, one challenge in NTNs may be determination of an appropriate measurement period for a UE to perform measurements of multiple satellites, potentially including multiple types of satellites. In RAN4 #102e meeting, the measurement design for NTN with multiple synchronization signal (SS) block (SSB) measurement timing configurations (SMTCs) has been discussed.

With regard to Issue 3-1-4B: Measurement with multiple SMTCs (Item-2: Scaling factor), the following agreements may be reached. A scaling factor may be applied to extend a total measurement period. In other words, a total (e.g., scaled) measurement period may be equal to a base measurement period (e.g., an SMTC period) multiplied by a scaling factor. When a UE is configured with multiple SMTCs on the same measurement carrier (not more than UE capability), the scaling factor may be determined according to option 1a or option 1c, discussed below.

Option 1a: If SMTCs do not overlap with each other, a scaling factor of measurement period may be: a) not needed, if only one low Earth orbit (LEO) satellite is designated to be measured within SMTC or b) proportional to the number of LEO satellite, if multiple LEO satellites are designated to be measured within SMTC. If SMTCs partially overlap with each other, a scaling factor of measurement period may be: a) proportional to the number of overlapping SMTCs, if only one LEO satellite is designated to be measured within SMTC or b) proportional to (the number of overlapping SMTCs)×(the number of LEO satellite), if multiple LEO satellites are designated to be measured within SMTC.

Option 1c: If each SMTC is associated with same type of satellites, and if SMTCs do not overlap with each other, and if LEO satellite(s) is/are designated to be measured within SMTC, then the scaling factor of measurement period on SMTC i may be given by K1:

$$K 1 = ⌈ \frac{number of LEO satellites in SMTC i}{\begin{matrix}number of LEO satellites UE is capable of measuring \\ in one SMTC\end{matrix}} ⌉$$

It will be appreciated that the ceiling function (e.g., the brackets in the above equation for K1) is a mathematical function that returns the smallest larger integer. For example, the ceiling function of 1.5 (e.g., or any real number between 1 and 2) evaluates to 2.

If SMTCs partially overlap with each other, and if LEO and/or GEO satellite(s) is/are to be measured within overlapped SMTCs, then the scaling factor of measurement period for overlapped SMTCs may be given by K2:

$$K 2 + number of overlapped SMTCs containing GEOs + {\sum }_{overlapped SMTC i containing LEOs} ⌈ \frac{number of LEO satellites in SMTC i}{\begin{matrix}number of LEO satellites UE is \\ capable of measuring in one SMTC\end{matrix}} ⌉$$

However, the RAN4 meeting did not address an appropriate scaling factor to use if each SMTC that is associated with mixed type of satellites when SMTCs are not overlapped or at least one SMTC that is associated with mixed type of satellites when SMTCs is overlapped with at least one other SMTC. As further discussed below, these cases (e.g., non-overlapped SMTCs each with mixed types of satellites as one case; overlapped SMTCs, at least one of which is mixed type as another case) may be treated separately. Thus, if each SMTC that is associated with mixed type of satellites (e.g., GEO and LEO) when SMTCs are not overlapped or at least one SMTC is associated with mixed type of satellites when SMTCs are overlapped and:

If SMTCs do not overlap with each other, and if LEO satellite(s) is/are designated to be measured within SMTC, then a scaling factor of measurement period on SMTC i may be given by X (e.g., various ways to calculate X are described below); and

If SMTCs partially overlap with each other, and if LEO and/or GEO satellite(s) is/are designated to be measured within overlapped SMTCs, then a scaling factor of measurement period for overlapped SMTCs may be given by Y (e.g., various ways to calculate Y are described below).

Note that a scaling factor X may be specific to a corresponding configuration (e.g., one X value may correspond to one SMTC); other (e.g., non-overlapped SMTCs) may have different scaling factors X. However, a (e.g., single) scaling factor Y may be used for multiple (e.g., overlapping) configurations. In other words, for X scaling factors (e.g., not overlapped case), the SMTCs may be scaled one by one (e.g., only SMTC with mixed satellite type may be scaled); but for Y scaling factors (e.g., overlapping case), SMTCs are overlapped (e.g., a GEO or LEO only SMTC and a mixed satellite SMTC are overlapped), the UE may coordinate the measurement resource among overlapped SMTCs and satellites, e.g., using a scaling factor Y. Thus, each SMTC may be mixed type for the X cases, but at least one SMTC may be mixed type for the Y cases.

One possibility for providing techniques for determining appropriate measurement periods (e.g., or determining scaling factors) may include an approach in which scaling factors may be determined based on factors such as number of satellites, types of satellites, and overlap between measurement configurations. To illustrate one such set of possible techniques, FIG. 8 is a flowchart diagram illustrating a method for determining measurement period in a non-terrestrial wireless communication system, at least according to some embodiments.

Aspects of the method of FIG. 8 may be implemented by a wireless device, e.g., in conjunction with one or more cellular base stations and/or satellites, such as a UE 106, BS 102, and/or satellite 500 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 8 are described in a manner relating to the use of communication techniques and/or features associated with 3GPP and/or NR specification documents, such description is not intended to be limiting to the disclosure, and aspects of the method of FIG. 8 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 8 may operate as follows.

The UE may establish a wireless link with a cellular network, e.g., via a base station, (802), according to some embodiments. According to some embodiments, the wireless link may include a cellular link according to 5G NR. For example, the UE may establish a session with an AMF entity of the cellular network by way of one or more BS/gNBs that provide radio access to the cellular network. As another possibility, the wireless link may include a cellular link according to LTE. For example, the UE may establish a session with a mobility management entity of the cellular network by way of a BS/eNB that provides radio access to the cellular network. Other types of cellular links are also possible, and the cellular network may also or alternatively operate according to another cellular communication technology (e.g., UMTS, CDMA2000, GSM, etc.), according to various embodiments.

In some embodiments, the wireless link may include multiple hops. For example, the wireless link may be established using one or more non-terrestrial network elements, such as a satellite, as a relay device. In such a scenario, the wireless link between the UE and the cellular base station may include a service link (e.g., between the UE and the satellite) and a feeder link (e.g., between the satellite and a cellular base station or another network element communicatively coupled with a cellular base station). Thus, the UE and the satellite may directly wirelessly communicate via the service link, and the satellite may relay those communications with the cellular base station via the feeder link.

In some embodiments, the wireless link may be a direct link to the cellular base station.

In some embodiments, the UE may establish multiple wireless links with the cellular network via one or more base stations. For example, the UE may establish one or more direct link with one or more BS and one or more indirect links (e.g., via one or more satellites) with one or more BS. In such a case, the BS(s) that the UE has direct links with may be the same and/or different from the BS(s) that the UE has indirect links with.

Establishing the wireless link may include establishing a RRC connection with a serving cellular base station, at least according to some embodiments. Establishing the first RRC connection may include configuring various parameters for communication between the UE and the cellular base station, establishing context information for the UE, and/or any of various other possible features, e.g., relating to establishing an air interface for the UE to perform cellular communication with a cellular network associated with the cellular base station. After establishing the RRC connection, the UE may operate in a RRC connected state. In some instances, the RRC connection may also be released (e.g., after a certain period of inactivity with respect to data communication), in which case the UE may operate in a RRC idle state or a RRC inactive state. In some instances, the UE may perform handover (e.g., while in RRC connected mode) or cell re-selection (e.g., while in RRC idle or RRC inactive mode) to a new serving cell, e.g., due to UE mobility, serving satellite mobility, changing wireless medium conditions, and/or for any of various other possible reasons.

At least in some instances, establishing the wireless link(s) may include the UE providing capability information for the UE. Such capability information may include information relating to any of a variety of types of UE capabilities.

As one example, the capability information may include information about capability for measuring reference signals (RS) from satellites. For example, such information may include a number of RS that may be measured simultaneously, amount of time to switch between RS, amount of time to perform measurements, etc. Suh information may be provided for various types of satellites (e.g., for individual types) and/or for various combinations of satellite types. For example, the capability information may include a first number of LEO (e.g., or any other type) satellites that the UE may measure during an SMTC period (e.g., or any defined time period, which may be indicated by the UE and/or network). Further, the capability information may include a second number of GEO satellites that the UE may measure during an SMTC period (e.g., or any defined time period). Similarly, the capability information may include a total number of satellites (e.g., of any combination of types) that the UE may measure during an SMTC period (e.g., or any defined time period).

As another example, the capability information may include an indication of whether or not the UE is capable of performing measurements of multiple satellite types simultaneously (e.g., in general or for specific combinations). For example, the UE may indicate whether it is capable of performing mixed satellite type measurement (e.g., of GEO and LEO satellites).

The capability information may include any necessary information, in view of a technical standard, for the UE and network (e.g., base station, serving cell, etc.) to determine the scaled measurement period (e.g., or the scaling factor) that the UE may use for a particular measurement scenario. In other words, the UE may provide any relevant information for the network to evaluate a scaling factor according to one or more of the equations discussed below.

As a further possibility, the network may provide configuration information to the UE. The configuration information may include information about satellite RS, such as timing, frequency, satellite type, etc. Further, the configuration information may include any number of measurement configurations, e.g., SMTCs.

In some embodiments, the network may configure the UE with a particular approach for measurements of satellite RS. For example, the network may indicate to the UE which equation to use to calculate scaling factor, e.g., in a particular instance or for one or more category of scenarios. Such a configuration may be negotiated with the UE, e.g., the UE may indicate preference for approach.

In some embodiments, the network may configure the UE to prioritize certain measurements (e.g., and/or measurement types) over others. Such prioritization may be SMTC specific. For example, the network may indicate to the UE to prioritize GEO measurements in one SMTC (e.g., and drop LEO measurements at any time that GEO and LEO overlap for that SMTC). It will be appreciated that to “drop” a measurement may mean to skip, omit, or not perform the measurement. For example, dropping LEO measurements may mean skipping measurements of LEO satellites, e.g., at a particular time. A different SMTC may have a different prioritization. As another possibility, the prioritization may be to drop all measurements in an SMTC, e.g., if there is overlap with another SMTC. Such a configuration may be negotiated with the UE, e.g., the UE may indicate preference for approach.

Various approaches for determining measurement period are discussed below.

According to a first approach (e.g., Approach 1), equal priority may be given to satellite measurements associated with different SMTCs. For example, if each SMTC is associated with mixed type of satellites (e.g., GEO and LEO), then the calculation of scaling factor may depend on whether the SMTCs overlap.

If SMTC #i does not overlap with any other SMTC, and if LEO satellite(s), and possibly also GEO satellite(s) is/are designated to be measured within SMTC #i, then a scaling factor of measurement period on SMTC #i may be given by X. (Note, if only GEO satellites are designated for SMTC #i, no scaling may be used, according to some embodiments.) X may be calculated according to either:

$$X 1 = ⌈ \frac{number of LEO satellites in SMTC i}{\begin{matrix}number of LEO satellites UE is capable of measuring \\ in one SMTC\end{matrix}} ⌉$$

$$or$$

$$X 2 = ⌈ \frac{number of LEO satellites in SMTC i}{\begin{matrix}number of satellites UE is capable of measuring \\ in one SMTC\end{matrix}} ⌉$$

It will be appreciated that X1 or X2 may be used consistent with the capability information. For example, if the capability information indicates a number of LEO satellites that the UE can measure in one SMTC (e.g., the denominator of X1), then X1 may be used. Similarly, if the capability information indicates a number of total satellites that the UE can measure in one SMTC (e.g., the denominator of X2), then X2 may be used.

Note that X1 and X2 may not depend on the number of GEO satellites, according to some embodiments. GEO satellites may be treated as same as the terrestrial base stations since GEOs are stationary to the UE. So, the new NTN capability and scaling factor may be designed for LEO satellite number, according to some embodiments.

If SMTCs partially overlap with each other, and if LEO and GEO satellite(s) is/are designated to be measured within at least one of the overlapped SMTCs, then the scaling factor of measurement period for overlapped SMTCs may be given by Y. Scaling factor Y may be used for (e.g., all of) the satellite measurements in the overlapped SMTCs. Y may be calculated according to either:

$$Y 1 = {\sum }_{overlapped SMTC i} ⌈ \frac{number of satellites in SMTC i}{\begin{matrix}number of satellites UE is capable of measuring \\ in one SMTC\end{matrix}} ⌉$$

$$or$$

$$Y 2 = {\sum }_{overlapped SMTC i} ⌈ \frac{number of satellites in SMTC i}{\begin{matrix}number of LEO satellites UE is capable of \\ measuring in one SMTC\end{matrix}} ⌉$$

As with X1 and X2, it will be appreciated that Y1 or Y2 may be used consistent with the capability information, e.g., according to whether the number of satellites the UE can measure per SMTC is provided per type of satellite or on a total basis. Further, it may be noted that Y1 may imply that all satellites would be treated in same priority, and UE could measure one SMTC at one time instance, while Y2 may imply that the capability of LEO measurement is extended to all satellites (e.g., regardless of type).

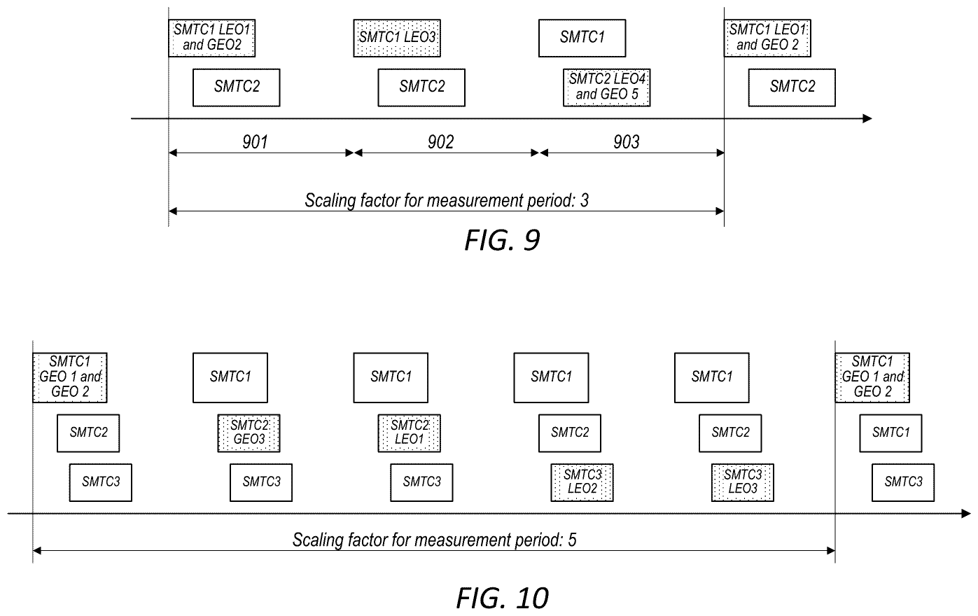

FIG. 9 illustrates an example measurement period and the calculation of scaling factor according to approach 1, according to some embodiments. As shown two SMTCs (e.g., 1 and 2) may be configured. SMTC 1 and SMTC 2 may be overlapped (e.g., Y may apply, rather than X). SMTC 1 (shown as the upper row) may include 2 LEO satellites and 1 GEO. SMTC 2 (lower row) may include 1 LEO and 1 GEO. The UE may have capability of measuring only 2 LEOs in one SMTC. As the capability information is expressed in a satellite type specific way, Y2 may be used. Y2 may be calculated as: ceiling (3/2)+ceiling (2/2)=2+1=3. For example, the first term may be calculated as ceiling of number of satellites in SMTC1 (e.g., 3)/number of LEO satellites the UE can measure (e.g., 2). Thus, the scaling factor may be 3.

In the illustrated example, in the first time period 901, the UE may measure satellites LEO1 and GEO2 according to SMTC 1. No measurement according to SMTC2 may be taken during 901. In 902, the UE may measure LEO3, thus completing the measurements for SMTC 1. In 903, the UE may measure LEO4 and GEO5, e.g., according to SMTC2. Thus, over the course of 3 (e.g., unscaled measurement periods) 901-903, the UE may measure each of the 5 satellites once, according to the combination of SMTCs 1 and 2. Using the scaling factor of 3, the periods 901-903 may be considered a single (e.g., scaled) measurement period.

According to a second approach (e.g., Approach 2), a UE may perform parallel measurement for GEO satellites (e.g., but may not perform parallel measurement for other satellites with the GEO satellites), according to some embodiments. In other words, the UE may measure one or more GEO satellites in a (e.g., un-scaled) SMTC period, but may not measure any LEO satellites during that period. Two variations (e.g., option 2-1 and 2-2) on approach 2 are explained below.

According to option 2-1, a UE may perform parallel measurement for GEO satellites, and LEO measurement may be performed separately from GEO.

If SMTC #i is associated with mixed type of satellites (e.g., GEO and LEO) and if the SMTC #i does not overlap with any other SMTC, then the scaling factor of measurement period on SMTC #i may be given by X. X may be calculated according to either:

$$X 1 = 1 + ⌈ \frac{number of LEO satellites in SMTC i}{\begin{matrix}number of LEO satellites UE is capable of measuring \\ in one SMTC\end{matrix}} ⌉$$

$$or$$

$$X 2 = 1 + ⌈ \frac{number of LEO satellites in SMTC i}{\begin{matrix}number of satellites UE is capable of measuring \\ in one SMTC\end{matrix}} ⌉$$

As noted above, X1 or X2 may be used consistent with the capability information.

Here the added ‘1’ (e.g., in comparison to Approach 1) may represent the time used for all parallel measurement for GEO satellites (e.g., the scaling factor may be increased by 1 to account for this time). In other words, in these equations, ‘1’ is added to a ceiling function of the number of satellites of one type (e.g., LEO) to account for measurements of one or more satellites of another type (e.g., GEO).

If at least one SMTC is associated with mixed type of satellites (e.g., GEO and LEO) and if SMTCs overlap (e.g., partially or completely) with each other, then the scaling factor of measurement period for overlapped SMTCs may be given by Y. Y may be calculate according to:

$$Y = number of SMTCs only containing GEO + {\sum }_{overlapped SMTC i containing only LEO} ⌈ \frac{number of satellites in SMTC i}{\begin{matrix}number of satellites UE is capable of measuring \\ in one SMTC\end{matrix}} ⌉ + {\sum }_{overlapped SMTC i containing LEO and GEO} ( 1 + ⌈ \frac{number of LEO satellites in SMTC i}{\begin{matrix}number of satellites UE is capable of measuring \\ in one SMTC\end{matrix}} ⌉ )$$

As noted above, the added ‘1’ may represent the time used for all parallel measurement for GEO satellites. Further, the number of satellites UE is capable of measuring in one SMTC may be consistent with the capability information, as described above. In other words, this number may include: a number of LEO satellites or number of all kinds of satellites, as reported in the capability information. In this equation, the number of measurement timing configurations that is/are for measurement of only a first type (e.g., GEO) of satellites may be added to a first summation over any measurement timing configurations that are for measurement of only a second type (e.g., LEO) of satellites; and a second summation over any measurement timing configurations that are for measurement of both the second type of satellites and the first type of satellites.

FIG. 10 illustrates an example measurement period and the calculation of scaling factor according to option 2-1, according to some embodiments. As shown, SMTC 1, SMTC 2 and SMTC 3 may be overlapped. SMTC 1 may include 2 GEOs, SMTC 2 may include 1 LEO and 1 GEO, and SMTC 3 may include 2 LEOs. The UE may have capability of measuring only Y 1 LEO in SMTC. Y may be calculated as follows: one Y=1+ceiling (2/1)+ (1+ceiling (1/1))=1+2+ (1+1)=5. For example, one SMTC (e.g., SMTC 1) may include only GEO satellites, thus the first term may be one. SMTC 3 may include only LEO satellites, thus SMTC 3 may be included in the second term (e.g., first summation) as ceiling (2/1), which may evaluate to 2. SMTC 2 may include LEO and GEO, thus SMTC 2 may be included in the third term (e.g., second summation) as 1+ceiling (1/1), which may evaluate as 1+1=2.

According to option 2-2, a UE may perform parallel measurement for GEO satellites. LEO measurement may be performed in parallel with GEO measurement. When LEO measurement is performed in parallel with GEO, all GEO measurement in this SMTC is treated as one LEO measurement (e.g., one LEO satellite measurement).

If SMTC #i is associated with mixed type of satellites (e.g., GEO and LEO) and if the SMTC #i does not overlap with any other SMTC, then the scaling factor of measurement period on SMTC #i may be given by X. X may be calculated according to any of:

$$X 1 = ⌈ \frac{1 + number of LEO satellites in SMTC i}{\begin{matrix}number of LEO satellites UE is capable of measuring \\ in one SMTC\end{matrix}} ⌉$$

$$or$$

$$X 2 = ⌈ \frac{number of satellites in SMTC i}{\begin{matrix}number of satellites UE is capable of measuring \\ in one SMTC\end{matrix}} ⌉$$

$$or$$

$$X 3 = ⌈ \frac{1 + number of LEO satellites in SMTC i}{\begin{matrix}number of satellites UE is capable of measuring \\ in one SMTC\end{matrix}} ⌉$$

$$or$$

$$X 4 = ⌈ \frac{number of satellites in SMTC i}{\begin{matrix}number of satellites UE is capable of measuring \\ in one SMTC\end{matrix}} ⌉$$

As noted above, X1-X4 may be used consistent with the capability information. Accordingly, the number of satellites UE is capable of measuring in one SMTC may include: number of LEO satellites, or number of all kinds of satellites.

Here the added ‘1’ (e.g., in the equations for X1 and X3) may represent the GEO measurements for the SMTC. In other words, all the GEO measurement in this SMTC may be treated with same priority as one LEO measurement (e.g., one LEO satellite measurement). The ‘1’ may be added to a first number of satellites of one type (e.g., LEO) inside of a ceiling function, e.g., to account for the measurement of one or more satellites of a second type (e.g., GEO).

If at least one SMTC is associated with mixed type of satellites (e.g., GEO and LEO) and overlaps (e.g., partially or completely) another SMTC, then the scaling factor of measurement period for overlapped SMTCs may be given by Y. Y may be calculated according to:

$$Y = number of SMTCs only containing GEO + {\sum }_{overlapped SMTC i containing only LEO} ⌈ \frac{number of satellites in SMTC i}{\begin{matrix}number of satellites UE is capable to measure \\ in one SMTC\end{matrix}} ⌉ + {\sum }_{overlapped SMTC i containing LEO and GEO} ( 1 + ⌈ \frac{number of LEO satellites in SMTC i}{\begin{matrix}number of satellites UE is capable to measure \\ in one SMTC\end{matrix}} ⌉ )$$

As noted above, Y may be used consistent with the capability information.

Accordingly, the number of satellites UE is capable of measuring in one SMTC may include: number of LEO satellites, or number of all kind of satellites.

Here the added ‘1’ may represent the GEO measurements for the SMTC. In other words, all the GEO measurement in this SMTC may be treated with same priority as one LEO measurement (e.g., one LEO satellite measurement).

The UE and the network may determine the timing of various satellite measurement opportunities (804), according to some embodiments. For example, the network and UE may determine whether the configured SMTCs for the UE overlap (e.g., partially or completely) in time. This determination may be made for any group of SMTCs for which the UE is configured to perform measurements.

The UE and the network may determine numbers of satellites of various satellite measurement opportunities (806), according to some embodiments. For example, the network and UE may determine numbers of satellites for the configured SMTCs for the UE. The network and UE may determine numbers of satellites in total, for each SMTC, and/or for each type of satellite. For example, the UE and network may determine respective numbers of satellites of (e.g., each of) multiple types that are configured for (e.g., each of) multiple SMTCs. This determination may be made for any group of SMTCs for which the UE is configured to perform measurements, e.g., the same group(s) as in 804.

It will be appreciated that the UE and network may perform the determinations (e.g., either or both of 804 and/or 806) independently of each other, but that the independent determinations may be based upon the same information (e.g., configuration information exchanged in 802, etc.), according to some embodiments. For example, the UE and network may not communicate about the determination(s). The UE and network may perform the determinations the same way, based on the same information. Further, these determinations may occur at the same time, different times, and/or in different orders. For example, the UE may perform 806 before 804; the network may perform 804 and 806 concurrently (and at a same or different time than the UE), etc.

The UE and the network may determine one or more scaling factor(s) (808), according to some embodiments. For example, the UE and network may determine the scaling factors using one or more of the formulas (e.g., for X or Y) discussed above regarding 802. The UE and network may select the appropriate formula(s) based on whether the measurement opportunities overlap and/or based on configuration information and/or technical standards. The UE and network may use capability information of the UE (e.g., related to the number of satellites the UE can measure in a period) and/or the various numbers of satellites associated with different measurement configurations or periods to evaluate the formula(s).

As with 804 and 806, it will be appreciated that the UE and network may perform the determination(s) of scaling factor(s) independently of each other, but that the independent determinations may be based upon the same information (e.g., configuration information exchanged in 802, determinations of 804 and 806, etc.), according to some embodiments. For example, the UE and network may not communicate about the determination(s). The UE and network may perform the determinations the same way, based on the same information. Further, these determinations may occur at the same time, different times, etc.

In some embodiments, e.g., according to some configurations, 808 may be omitted. For example, as discussed herein, scaling factors may not be used under some circumstances and/or for some configurations.

One or more satellites (e.g., of one or more types) may transmit RS (e.g., SSB) and the UE may receive the RS (810), according to some embodiments.

The UE may perform measurement(s) of the RS (812), according to some embodiments. The measurement(s) may be performed according to the configuration information, and, if applicable, using the scaling factor(s). The measurement(s) may include measurements of signal strength (e.g., received signal strength indicator (RSSI), etc.), quality, interference, noise, frequency, phase, timing, etc.

As noted above, in some embodiments, measurement and/or scaling may be performed differently based on capabilities of the UE (e.g., as reported in capability information).

For example, according to a third approach (e.g., Approach 3) a UE capability based mixed satellite measurement may be used. The UE may (e.g., in 802) report a new capability for mixed satellite measurement including GEO and LEO measurement. If the UE reports support/capability of mixed GEO and LEO measurement, then option 2-2 in approach 2 or approach may be used. Otherwise (e.g., if UE reports not supporting mixed GEO and LEO measurement, then one of the following may be used:
a) option 2-1 in approach 2,
b) no scaling factor may be used and the UE may prioritize GEO measurement in any SMTC with mixed satellite types and drop all LEO measurement in this SMTC,
c) no scaling factor may be used and the UE may prioritize LEO measurement in any SMTC with mixed satellite and drop all GEO measurement in this SMTC,
d) no scaling factor may be used. The network may indicate (e.g., in 802 and/or at any other time, such as when RS is received in 810) to the UE which type of satellite measurement shall be prioritized in this SMTC with mixed satellite (e.g., implying that other type(s) should not be performed), or
e) no scaling factor may be used and the UE may drop all measurement in an indicated SMTC. In other words, the UE may skip this SMTC in this radio resource management (RRM) measurement procedure. This may allow the UE to perform measurements according to one or more other (e.g., overlapping) SMTC, e.g., without use of a scaling factor.

As another example, according to a fourth approach (Approach 4) a default handling for SMTC with mixed measurement may be established. Approach 4 may be performed without an indication of the UE's capability (e.g., for measuring satellites) and without use of a scaling factor. According to approach 4, the network may provide configuration information to allow UE to drop (e.g., by default) all or part of the measurement in the SMTC with mixed satellite types. For example, the network may indicate (e.g., in 802 and/or at any other time) one of the following:
a) UE may prioritize GEO measurement in the SMTC(s) with mixed satellite and drop all LEO measurement in this SMTC(s),
b) UE may prioritize LEO measurement in the SMTC(s) with mixed satellite and drop all GEO measurement in this SMTC(s),
c) the network may indicate (e.g., in 802 and/or at any other time) to the UE which satellite measurement to prioritize in a particular SMTC with mixed satellite, or
d) the UE may drop all measurement in an indicated SMTC. In other words, the UE may skip this SMTC in this RRM measurement procedure. This may allow the UE to perform measurements according to one or more other (e.g., overlapping) SMTC, e.g., without use of a scaling factor.

The UE may transmit a report(s) of any or all of the measurement(s) to the network (814), according to some embodiments. The measurement(s) may be reported in any of various formats, message types, etc., as desired. For example, the UE may transmit measurements for each SMTC, according to some embodiments.

The network (e.g., BS, serving cell, etc.) may receive the report(s).

In some embodiments, the network may use the scaling factor(s) determined in 808 to interpret the report. For example, the network may adjust the reported measurement(s) based on the corresponding scaling factor(s).

In some embodiments, the network may use configuration information to interpret the report(s). For example, based on the configuration information, the network may determine which (if any) measurements were dropped by the UE.

The network may interpret the report(s) in view of configuration information and/or scaling factor(s) that is/are specific to the corresponding SMTC or measurement. For example, different SMTCs may be scaled differently (e.g., including that some may not be scaled at all).

In some embodiments, the UE may report the approach(es) and/or scaling factor(s) associated with the measurement(s).

Thus, at least according to some embodiments, the method of FIG. 8 may be used to provide a framework according to which a wireless device and network may reach a common understanding of UE measurements of satellite RS in a non-terrestrial wireless communication system, at least in some instances.

### Additional Information

The following additional information describes further aspects that might be used in conjunction with the method of FIG. 8 if desired. It should be noted, however, that the exemplary details described in the following section are not intended to be limiting to the disclosure as a whole: numerous variations and alternatives to the details provided herein below are possible and should be considered within the scope of the disclosure.

Although aspects of the method of FIG. 8 are described with respect to GEO and LEO satellites, it will be appreciated that the method of FIG. 8 may apply to any types of satellites, including more than two types of satellites. For example, additional types may be included and/or alternative types may be used as desired.

In the following further exemplary embodiments are provided.

One set of embodiments may include a method, comprising: by a user equipment device (UE): establishing communication with a cellular network; receiving, from the cellular network, configuration information comprising at least: a first measurement timing configuration for measurement of satellite reference signals from satellites of multiple types; and a second measurement timing configuration, different from the first measurement timing configuration, for measurement of satellite reference signals; determining whether first measurement opportunities according to the first measurement timing configuration overlap with second measurement opportunities according to the second measurement timing configuration in a time domain; determining a first number of satellites associated with the first measurement timing configuration; determining a first scaling factor based at least on: whether the first measurement opportunities overlap with the second measurement opportunities in the time domain; and the first number of satellites; and performing first measurements of satellite reference signals according to the first measurement timing configuration, wherein a time period for the first measurements is determined based on the first scaling factor.

In some embodiments, the method may further comprise transmitting, to the cellular network, capability information comprising an indication of a number of satellites that the UE can measure during a first duration of time, wherein the first scaling factor is further determined based at least on the number of satellites that the UE can measure during the first duration of time.

In some embodiments, the number of satellites that the UE can measure during the first duration of time is specific to a first type of satellites; and the first number of satellites is specific to the first type of satellites.

In some embodiments, the number of satellites that the UE can measure during the first duration of time is for multiple types of satellites; and the first number of satellites is for the multiple types of satellites.

In some embodiments, the first measurement opportunities do not overlap with the second measurement opportunities in the time domain; the number of satellites that the UE can measure during the first duration of time is for multiple types of satellites; and the first number of satellites is specific to a first type of satellites.

In some embodiments, the method may further comprise determining a number of measurement timing configurations that is/are for measurement of only a first type of satellites, wherein the first scaling factor is further determined based at least on the number of measurement timing configurations that is/are for measurement of only the first type of satellites.

In some embodiments, the first scaling factor is further determined using an equation in which the number of measurement timing configurations that is/are for measurement of only the first type of satellites is added to: a first summation over any measurement timing configurations that are for measurement of only a second type of satellites; and a second summation over any measurement timing configurations that are for measurement of both the second type of satellites and the first type of satellites.

In some embodiments, the first measurement opportunities do not overlap with the second measurement opportunities in the time domain; performing first measurements of satellite reference signals according to the first measurement timing configuration comprises performing measurements of satellites of a first type of satellites in parallel; the first number of satellites is specific to a second type of satellites different from the first type of satellites; and the first scaling factor is further determined using an equation in which a ‘l’ is added to the first number of satellites inside of a ceiling function.

In some embodiments, the first measurement opportunities do not overlap with the second measurement opportunities in the time domain; performing first measurements of satellite reference signals according to the first measurement timing configuration comprises performing measurements of satellites of a first type of satellites in parallel; the first number of satellites is specific to a second type of satellites different from the first type of satellites; and the first scaling factor is further determined using an equation in which a ‘l’ is added to a ceiling function of the first number of satellites.

In some embodiments, the first measurement opportunities do overlap with the second measurement opportunities in the time domain; and the first scaling factor is further determined using an equation in which a ceiling function of the number of satellites associated with a respective measurement timing configuration in summed over multiple measurement timing configurations, including at least the first measurement timing configuration and the second measurement timing configuration.

In some embodiments, the method may further comprise performing second measurements of satellite reference signals according to the second measurement timing configuration, wherein a time period for the second measurements is determined based on the first scaling factor.

In some embodiments, the method may further comprise performing second measurements of satellite reference signals according to the second measurement timing configuration, wherein a time period for the second measurements is determined based on a second scaling factor different from the first scaling factor.

Another set of embodiments may include a method, comprising: by a user equipment device (UE): establishing communication with a cellular network; receiving, from the cellular network, configuration information comprising at least: a first measurement timing configuration for measurement of satellite reference signals from satellites of multiple types; and a second measurement timing configuration, different from the first measurement timing configuration, for measurement of satellite reference signals; and performing first measurements of satellite reference signals according to the first measurement timing configuration, wherein said performing first measurements comprises one of: prioritizing measurement of a first type of satellites and dropping measurement of a second type of satellites; prioritizing measurement of at least one satellite indicated by the cellular network for prioritization; or dropping all measurement for the first measurement timing configuration.

Another set of embodiments may include a method, comprising: by a cellular base station: establishing communication with a user equipment device (UE); transmitting, to the UE, configuration information comprising at least: a first measurement timing configuration for measurement of satellite reference signals from satellites of multiple types; and a second measurement timing configuration, different from the first measurement timing configuration, for measurement of satellite reference signals; determining whether first measurement opportunities according to the first measurement timing configuration overlap with second measurement opportunities according to the second measurement timing configuration in a time domain; determining a first number of satellites associated with the first measurement timing configuration; determining a first scaling factor based at least on: whether the first measurement opportunities overlap with the second measurement opportunities in the time domain; and the first number of satellites; and receiving, from the UE, a report of first measurements of satellite reference signals according to the first measurement timing configuration, wherein a time period for the first measurements is determined based on the first scaling factor.

In some embodiments, the method may further comprise: receiving, from the UE, capability information comprising an indication of a number of satellites that the UE can measure during a first duration of time, wherein the first scaling factor is further determined based at least on the number of satellites that the UE can measure during the first duration of time.

In some embodiments, the method may further comprise: determining a number of measurement timing configurations that is/are for measurement of only a first type of satellites, wherein the first scaling factor is further determined based at least on the number of measurement timing configurations that is/are for measurement of only the first type of satellites.

In some embodiments, the first measurement opportunities do overlap with the second measurement opportunities in the time domain; and the first scaling factor is further determined using an equation in which a ceiling function of the number of satellites associated with a respective measurement timing configuration in summed over multiple measurement timing configurations, including at least the first measurement timing configuration and the second measurement timing configuration.

A further set of embodiments may include a computer program product, comprising computer instructions which, when executed by one or more processors, perform steps of any of the methods of the preceding examples.

Yet another set of embodiments may include a cellular base station, comprising: one or more processors; and a memory having instructions stored thereon, which when executed by the one or more processors, perform steps of any of the methods of the preceding examples.

A yet further set of embodiments may include a computer program product, comprising computer instructions which, when executed by one or more processors, perform steps of any of the methods of the preceding examples.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
communicating with a cellular network;
receiving, from the cellular network, configuration information comprising at least:
a first measurement timing configuration for measurement of satellite reference signals from satellites of multiple types; and
a second measurement timing configuration, different from the first measurement timing configuration, for measurement of satellite reference signals;
determining whether first measurement opportunities according to the first measurement timing configuration overlap with second measurement opportunities according to the second measurement timing configuration in a time domain;
determining a first number of satellites associated with the first measurement timing configuration;
determining a first scaling factor based at least on:
whether the first measurement opportunities overlap with the second measurement opportunities in the time domain; and
the first number of satellites; and
performing first measurements of satellite reference signals according to the first measurement timing configuration, wherein a time period for the first measurements is determined based on the first scaling factor.

2. The method of claim 1, further comprising:
transmitting, to the cellular network, capability information comprising an indication of a number of satellites measurable during a first duration of time, wherein the first scaling factor is further determined based at least on the number of satellites measurable during the first duration of time.

3. The method of claim 2, wherein:
the number of satellites measurable during the first duration of time is specific to a first type of satellites; and
the first number of satellites is specific to the first type of satellites.

4. The method of claim 2, wherein:
the number of satellites measurable during the first duration of time is for multiple types of satellites; and
the first number of satellites is for the multiple types of satellites.

5. The method of claim 2, wherein:
the first measurement opportunities do not overlap with the second measurement opportunities in the time domain;
the number of satellites measurable during the first duration of time is for multiple types of satellites; and
the first number of satellites is specific to a first type of satellites.

6. The method of claim 1, further comprising:
determining a number of measurement timing configurations that is/are for measurement of only a first type of satellites, wherein the first scaling factor is further determined based at least on the number of measurement timing configurations that is/are for measurement of only the first type of satellites.

7. The method of claim 6, wherein the first scaling factor is further determined using an equation in which the number of measurement timing configurations that is/are for measurement of only the first type of satellites is added to:
a first summation over any measurement timing configurations that are for measurement of only a second type of satellites; and
a second summation over any measurement timing configurations that are for measurement of both the second type of satellites and the first type of satellites.

8. The method of claim 1, wherein:
the first measurement opportunities do not overlap with the second measurement opportunities in the time domain;
performing first measurements of satellite reference signals according to the first measurement timing configuration comprises performing measurements of satellites of a first type of satellites in parallel;
the first number of satellites is specific to a second type of satellites different from the first type of satellites; and
the first scaling factor is further determined using an equation in which a ‘1’ is added to the first number of satellites inside of a ceiling function.

9. The method of claim 1, wherein:
the first measurement opportunities do not overlap with the second measurement opportunities in the time domain;
performing first measurements of satellite reference signals according to the first measurement timing configuration comprises performing measurements of satellites of a first type of satellites in parallel;
the first number of satellites is specific to a second type of satellites different from the first type of satellites; and
the first scaling factor is further determined using an equation in which a ‘1’ is added to a ceiling function of the first number of satellites.

10. The method of claim 1, wherein:
the first measurement opportunities do overlap with the second measurement opportunities in the time domain; and
the first scaling factor is further determined using an equation in which a ceiling function of a number of satellites associated with a respective measurement timing configuration in summed over multiple measurement timing configurations, including at least the first measurement timing configuration and the second measurement timing configuration.

11. The method of claim 1, further comprising:
performing second measurements of satellite reference signals according to the second measurement timing configuration, wherein a time period for the second measurements is determined based on the first scaling factor.

12. The method of claim 1, further comprising:
performing second measurements of satellite reference signals according to the second measurement timing configuration, wherein a time period for the second measurements is determined based on a second scaling factor different from the first scaling factor.

13. An apparatus, comprising:
a processor configured to, when executing instructions stored in a memory, perform operations comprising:
communicating with a cellular network;
receiving, from the cellular network, configuration information comprising at least:
a first measurement timing configuration for measurement of satellite reference signals from satellites of multiple types; and
a second measurement timing configuration, different from the first measurement timing configuration, for measurement of satellite reference signals;
determining whether first measurement opportunities according to the first measurement timing configuration overlap with second measurement opportunities according to the second measurement timing configuration in a time domain;
determining a first number of satellites associated with the first measurement timing configuration;
determining a first scaling factor based at least on:
whether the first measurement opportunities overlap with the second measurement opportunities in the time domain; and
the first number of satellites; and
performing first measurements of satellite reference signals according to the first measurement timing configuration, wherein a time period for the first measurements is determined based on the first scaling factor.

14. The apparatus of claim 13, the operations further comprising:
transmitting, to the cellular network, capability information comprising an indication of a number of satellites measurable during a first duration of time, wherein the first scaling factor is further determined based at least on the number of satellites measurable during the first duration of time.

15. The apparatus of claim 13, the operations further comprising:
determining a number of measurement timing configurations that is/are for measurement of only a first type of satellites, wherein the first scaling factor is further determined based at least on the number of measurement timing configurations that is/are for measurement of only the first type of satellites.

16. The apparatus of claim 13, wherein:
the first measurement opportunities do not overlap with the second measurement opportunities in the time domain;
performing first measurements of satellite reference signals according to the first measurement timing configuration comprises performing measurements of satellites of a first type of satellites in parallel;
the first number of satellites is specific to a second type of satellites different from the first type of satellites; and
the first scaling factor is further determined using an equation in which a ‘1’ is added to the first number of satellites inside of a ceiling function.

17. A method, comprising:
communicating with a user equipment device (UE);
transmitting, to the UE, configuration information comprising at least:
a first measurement timing configuration for measurement of satellite reference signals from satellites of multiple types; and
a second measurement timing configuration, different from the first measurement timing configuration, for measurement of satellite reference signals;
determining whether first measurement opportunities according to the first measurement timing configuration overlap with second measurement opportunities according to the second measurement timing configuration in a time domain;
determining a first number of satellites associated with the first measurement timing configuration;
determining a first scaling factor based at least on:
whether the first measurement opportunities overlap with the second measurement opportunities in the time domain; and
the first number of satellites; and
receiving, from the UE, a report of first measurements of satellite reference signals according to the first measurement timing configuration, wherein a time period for the first measurements is determined based on the first scaling factor.

18. The method of claim 17, further comprising:
receiving, from the UE, capability information comprising an indication of a number of satellites measurable during a first duration of time, wherein the first scaling factor is further determined based at least on the number of satellites measurable during the first duration of time.

19. The method of claim 17, further comprising:
determining a number of measurement timing configurations that is/are for measurement of only a first type of satellites, wherein the first scaling factor is further determined based at least on the number of measurement timing configurations that is/are for measurement of only the first type of satellites.

20. The method of claim 17, wherein:
the first measurement opportunities do overlap with the second measurement opportunities in the time domain; and
the first scaling factor is further determined using an equation in which a ceiling function of a number of satellites associated with a respective measurement timing configuration in summed over multiple measurement timing configurations, including at least the first measurement timing configuration and the second measurement timing configuration.
